(19) United States
(12) Patent Application Publication
(10) Pub. No.: US 2018/0232686 A1
(43) Pub. Date: Aug. 16, 2018

(54) ARTICLE MANAGEMENT APPARATUS AND ARTICLE MANAGEMENT METHOD

(71) Applicant: TOSHIBA TEC KABUSHIKI KAISHA, Tokyo (JP)

(72) Inventor: Masaaki YASUNAGA, Sunto Shizuoka (JP)

(21) Appl. No.: 15/434,348

(22) Filed: Feb. 16, 2017

(51) Int. Cl. G06Q 10/08; G06K 9/32; G06T 7/70; G06K 9/46; G06K 9/00; G06K 7/10

(52) U.S. Cl. CPC G06Q 10/087; G06K 9/3258; G06T 7/70; G06K 9/4671; G06T 2207/30252; G06K 7/10861; G06T 2207/10004; G06T 2207/30204; G06K 9/00791

(57) ABSTRACT

According to one embodiment, an article management apparatus includes an interface and a processor. The interface acquires a image captured by photographing a check range including an area where an article and a label are arranged. The processor specifies a kind and a position of the article existing in the image, specifies a position of the label existing in the image, and determines whether the position of the label specified from the image is a correct position according to an arrangement rule, relative to the position of the article specified from the image.

### FIELD

Embodiments described herein relate generally to an article management apparatus and an article management method.

### BACKGROUND

In stores such as retail stores, in general, products are arranged in a display rack, and labels (price tags) indicating prices, etc. are disposed near the products. In this operational use, if the positional relationship between the products and the corresponding labels is irregular, a person who looks at the products would have difficulty in recognizing the products in association with the corresponding labels. As related art of managing articles in a rack, there is known a system which recognizes unique IDs (characters or bar codes) which are attached to the spines of books, and determines whether the arrangement of books in the rack is correct or not. However, in the related art, it is not possible to determine whether the positional relationship between articles, such as products, and labels indicating the information of the articles, is proper or not.

### BRIEF DESCRIPTION OF THE DRAWINGS

FIG. 1 is a view which schematically illustrates a configuration example of an article management apparatus according to a first embodiment.

FIG. 2 is a block diagram illustrating a configuration example of a control system of the article management apparatus.

FIG. 3 is a view illustrating an example of the arrangement of a plurality of products and a plurality of labels in a display rack, which the article management apparatus inspects as targets.

FIG. 4 is a flowchart for describing an operation example of the article management apparatus.

FIG. 5 is a flowchart for describing an operation example of a label detection process in the article management apparatus.

FIG. 6 is a flowchart for describing an operation example of a label position determination process in the article management apparatus.

FIG. 7 is a flowchart for describing an operation example of an article management apparatus according to a second embodiment.

FIG. 8 is a flowchart for describing an operation example of an article management apparatus according to a third embodiment.

### DETAILED DESCRIPTION

In general, according to one embodiment, an article management apparatus includes an interface and a processor. The interface acquires a image captured by photographing a check range including an area where an article and a label are arranged. The processor specifies a kind and a position of the article existing in the image, specifies a position of the label existing in the image, and determines whether the position of the label specified from the image is a correct position according to an arrangement rule, relative to the position of the article specified from the image.

Various embodiments will be described hereinafter with reference to the accompanying drawings.

### First Embodiment

To begin with, an article management apparatus according to a first embodiment will be described.

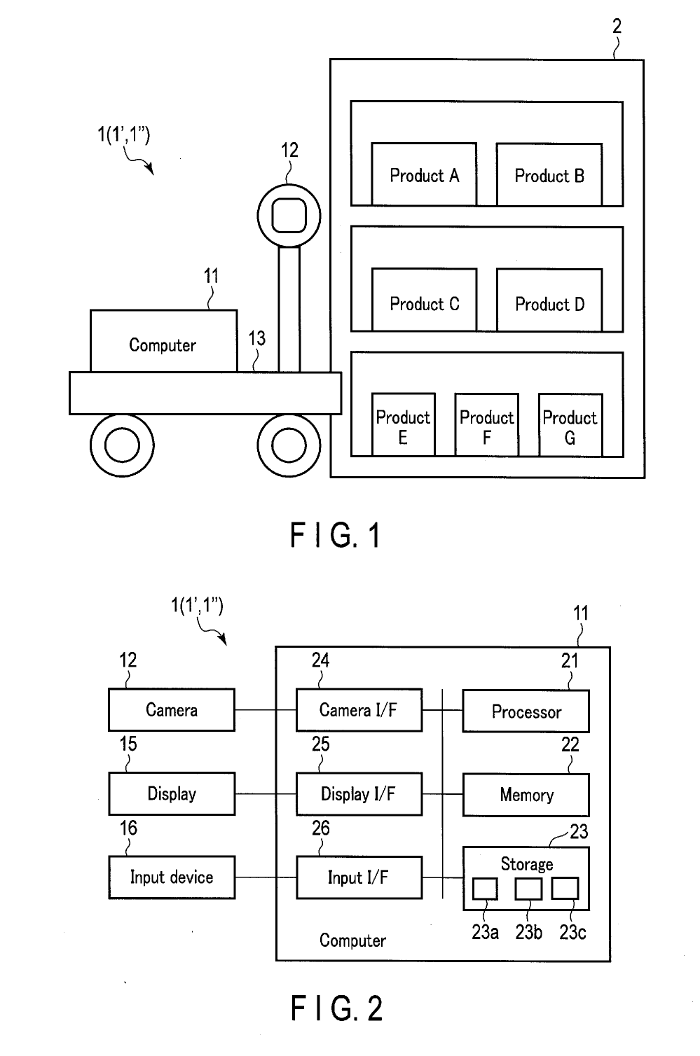

FIG. 1 is a view which schematically illustrates a configuration example of an article management apparatus 1 according to the first embodiment.

The article management apparatus 1 is an apparatus which checks whether the arrangement between articles and labels, which indicate the information of the articles, is in a proper positional relationship or not. For example, the article management apparatus 1 is a rack management apparatus which determines whether various kinds of articles arranged in a display rack (rack) 2 and labels corresponding to these articles are in a predetermined positional relationship or not. Specifically, the articles and the labels corresponding to the articles, which are targets of management of the article management apparatus 1, are arranged at positions according to predetermined arrangement rules.

The articles are disposed in specific areas on a kind-by-kind basis. For example, the articles are products which are arranged on a kind-by-kind basis in the display rack 2 that is disposed in a store or the like. The labels indicate article information (article name, price, identification information) relating to the corresponding articles. The label may be of any type if the label indicates the article information. For example, the label may be a paper sheet on which the article information is described, or may be a display (electronic rack label) which displays the article information. Besides, the label may be an electronic device, such as an RFID, which outputs the article information.

In the meantime, the article management apparatus 1 according to each of the embodiments is not limited to an apparatus which checks the positional relationship between the products, which are arranged in the display rack disposed in the store, and the corresponding labels. The article management apparatus 1 according to each embodiment may be any apparatus if the apparatus checks the positional relationship between articles arranged in a rack or the like, and labels. However, the descriptions below will be given on the assumption that the articles are products which are arranged in the display rack 2, and the labels are labels indicating the product information of the corresponding products.

In the configuration example illustrated in FIG. 1, the article management apparatus 1 includes a computer 11, a camera 12 and a truck 13.

The computer 11 checks whether the positional relationship between respective products and labels meets a predetermined rule, based on an image which the camera 12 photographed. The computer 11 is an information processing apparatus including various kinds of input/output interfaces. The computer 11 realizes various processing functions (to be described later) by a processor executing programs. A configuration example of a control system of the computer 11 will be described later in detail.

The camera 12 photographs an image of a range (check range) for checking the positional relationship between products and labels. The camera 12 may be of any kind if the camera 12 photographs an image of the check range in the state in which the computer 11 can recognize products and labels. The camera 12 is configured to photograph the display rack 2 as an area where products and labels of check targets are arranged. The camera 12 and computer 11 are communicably connected. The camera 12 may be connected to the computer 11 via a communication cable, or may be connected to the computer 11 by wireless communication. The camera 12 photographs an image in accordance with a signal from the computer 11. The camera 12 transmits the photography image to the computer 11.

The truck 13 mounts thereon the computer 11 and camera 12. The truck 13 moves in the state in which the computer 11 and camera 12 are mounted on the truck 13. The truck 13 is an example of a moving mechanism for moving the camera 12 such that the camera 12 photographs an image of the check range. For example, a clerk in charge pushes the truck 13, and thereby the truck 13 moves. In addition, the truck 13 may be a self-driving truck which moves in accordance with a control instruction from the computer 11. In the configuration example illustrated in FIG. 1, the camera 12 is fixed to the truck 13 by a support member, and the camera 12 photographs an image of the check range while the truck 13 is moving. Besides, the article management apparatus 1 may be equipped with a mechanism for vertically moving the position of the camera 12.

In the meantime, the article management apparatus 1 may not include the truck 13, if the camera 12 can move so as to photograph an image of the entirety of the check range. For example, the article management apparatus 1 may be composed of the camera 12, which is fixed to such a specific position as to be capable of photographing the entirety of the display rack 2 that is the check range, and the computer 11. Additionally, the camera 12 may be composed of a plurality of imaging units which photograph respective portions of the display rack 2 from fixed positions. Additionally, the camera 12 may be a portable camera which an operator can freely move.

Furthermore, the article management apparatus 1 may be of any type if the article management apparatus 1 includes a function of acquiring a photography image of the check range, and a function of executing information processing based on the photography image. The article management apparatus 1 is not limited to the configuration illustrated in FIG. 1, and may be realized by, for example, a camera-equipped mobile terminal (tablet PC, smartphone, electronic camera, etc.). The camera-equipped mobile terminal can photograph an image of the check range by the operation of the operator, and can execute a process based on the photography image.

The display rack 2 includes frames which form shelves on which a plurality of products are disposed. In addition, the display rack 2 may include hooks for hanging products. In the configuration example illustrated in FIG. 1, the display rack 2 includes frames which form three shelves (upper, middle and lower shelves) for arranging products. It should suffice, however, if the display rack 2 is configured such that a plurality of kinds of products can be arranged. The size, the number of shelves, and the shape of the display rack 2 are not limited to specific configurations.

In the display rack 2, a plurality of kinds of products are arranged on a kind-by-kind basis. For example, in the display rack 2, products of the same kind are arranged in one row or plural rows from the front side toward the rear side. In the display rack 2, the foremost (frontmost) product of each row is disposed such that the package of the product is easily visually recognizable. Thereby, in the display rack 2, the packages of various kinds of products are disposed such that persons can easily visually recognize the packages.

Labels for showing information relating to products to users are arranged in association with various kinds of products arranged in the display rack 2. The products and labels are arranged in a positional relationship according to predetermined arrangement rules (to be described later). For example, labels corresponding to various kinds of products are arranged at positions according to the arrangement rules, in association with the various kinds of products in the display rack 2.

Next, the configuration of the control system of the article management apparatus 1 will be described.

FIG. 2 is a block diagram illustrating a configuration example of the control system of the article management apparatus 1.

As illustrated in FIG. 2, the article management apparatus 1 includes the computer 11, the camera 12, a display 15 and an input device 16. The computer 11 includes a processor 21, a memory 22, a storage 23, a camera interface (I/F) 24, a display interface (I/F) 25, and an input device interface (I/F) 26.

The processor 21 realizes various kinds of processing functions by executing programs. The processor 21 is, for example, a CPU. The processor 21 realizes various processing functions which will be described later, by executing programs stored in a nonvolatile memory in the memory 22, or in the storage 23.

In the meantime, some of the processing functions (to be described later), which the processor 21 realizes by executing the programs, may be realized by hardware circuitry.

The memory 22 stores data for control. The memory 22 includes, for example, storage devices such as a ROM and a RAM. The ROM is a nonvolatile memory which stores programs for control, and control data. The RAM is a volatile memory. The RAM temporarily stores, for instance, data which is being processed. For example, the RAM stores an application program which the processor 21 executes. In addition, the RAM may store data which is necessary for executing the application program, and an execution result of the application program.

The storage 23 includes a data rewritable nonvolatile memory. The storage 23 is composed of, for example, a hard disk drive (HDD), a solid state drive (SSD), or a flash memory. The storage 23 may store programs and various data corresponding to purposes of operational use of the article management apparatus 1.

In the configuration example illustrated in FIG. 2, the storage 23 includes storage areas 23a, 23b and 23c. The storage area 23a is a product DB which stores information (product identification information) for identifying (recognizing) products. The storage area 23b is a rule DB which stores information indicating rules that stipulate the positional relationship between products and labels. The storage area 23c is an arrangement plan DB which stores information (arrangement plan information) indicating a product arrangement plan.

In the meantime, it should suffice if the product DB, rule DB and arrangement plan DB are databases which the processor 21 can access, and these databases may be provided outside the computer 11 (i.e. in an external apparatus). For example, the product DB, rule DB or arrangement plan DB may be provided in a memory of an external apparatus which the processor 21 can access. If the product DB, rule DB or arrangement plan DB is provided in the memory which the external apparatus includes, the computer 11 is configured to include an interface for communication with the external apparatus.

The product identification information, which is stored in the storage area 23a as the product DB, is information for identifying products from the photography image. Product identification information relating to all products, which are recognition targets, is registered in the storage area (product DB) 23a. The product identification information includes information (identification information), which uniquely identifies products, and information (characteristic information) which is necessary for recognizing products from the photography image. The identification information is unique information for uniquely identifying the kind of a product or uniquely identifying a product, such as a product name, a product ID or a bar code. The characteristic information is information which is necessary for recognizing or detecting products from the image. For example, the characteristic information is information, such as a characteristic amount, which corresponds to a processing method (e.g. SIFT or HOG) for use in a product recognition process. Besides, image data of a product may be stored as the characteristic information. The characteristic information may include 3D data of a product.

The storage area 23b serving as the rule DB stores information indicating arrangement rules which stipulate the positional relationship between products and labels. The arrangement rules, which the storage area (rule DB) 23b stores, are rules which stipulate the positional relationship between products and labels corresponding to the products, in accordance with the types of products, the state of products, or the state of shelves of the rack. The arrangement rules are stipulated in accordance with the mode of operational use. An example of the arrangement rules will be described later.

The information, which is stored in the storage area 23c serving as the arrangement plan DB, is information indicating a plan for arranging products and labels in the display rack 2. The storage area (arrangement plan DB) 23c stores product arrangement plan information (e.g. Planogram Master) indicating products which are arranged in the display rack 2, the positions of the products, and the positions of the labels corresponding to the products. The product arrangement plan information is information which associates the products that are arranged, the coordinates at which the products are disposed, and the coordinates at which the labels corresponding to the products are disposed. Incidentally, the product arrangement plan information is stipulated in accordance with the mode of operational use, and may be updated as needed.

The camera interface 24 is an interface for communication with the camera 12. For example, in accordance with a signal from the processor 21, the camera interface 24 transmits to the camera 12 a signal for causing the camera 12 to photograph an image. In addition, the camera interface 24 transmits the image, which the camera 12 photographed, to the processor 21. For example, the camera interface 24 may be an interface which supports a USB connection.

The display interface (display I/F) 25 is connected to the display 15. The display I/F 25 relays data input/output between the processor 21 and display 15. The display 15 displays a screen, based on a display control which is delivered from the processor 21 via the display I/F 25. The display 15 includes a display panel, and a driving circuit which causes the display panel to display a screen. The display panel is, for example, a display device such as a liquid crystal display or an organic EL display.

The input device interface (input I/F) 26 is connected to the input device 16. The input I/F 26 relays data input/output between the processor 21 and input device 16. The input device 16 supplies information, which the user inputs by using an operation member, to the processor 21 via the input I/F 26. The operation member of the input device 16 is, for example, a touch sensor, a keyboard, or numeric keys. The touch sensor is, for example, a resistive touch sensor or a capacitive touch sensor. The touch sensor may be configured as a touch screen as one piece with the display panel of the display 15.

Next, the arrangement rules will be described.

The arrangement rules are information which stipulates the positional relationship between products and labels. The arrangement rules are stored in the storage area (rule DB) 23b. In the meantime, it should suffice if the storage area (rule DB) 23b is a medium which the processor 21 of the article management apparatus 1 can access. The arrangement rules stipulate the positions of labels relative to respective products, in accordance with the states of products, such as the manner of disposition of products (e.g. direct placement, hanging, etc.), the positions for placement (positions of shelves of the rack), and the state of disposition of the same type of products (stacking, disposition in rows). In addition, the arrangement rules may be rules which stipulate the positions of labels corresponding to respective products, in accordance with the state (kind) of the rack. Besides, the arrangement rules may be rule which stipulate the positions of labels corresponding to respective products in accordance with the kinds of products. Such arrangement rules are properly stipulated in accordance with the mode of operational use.

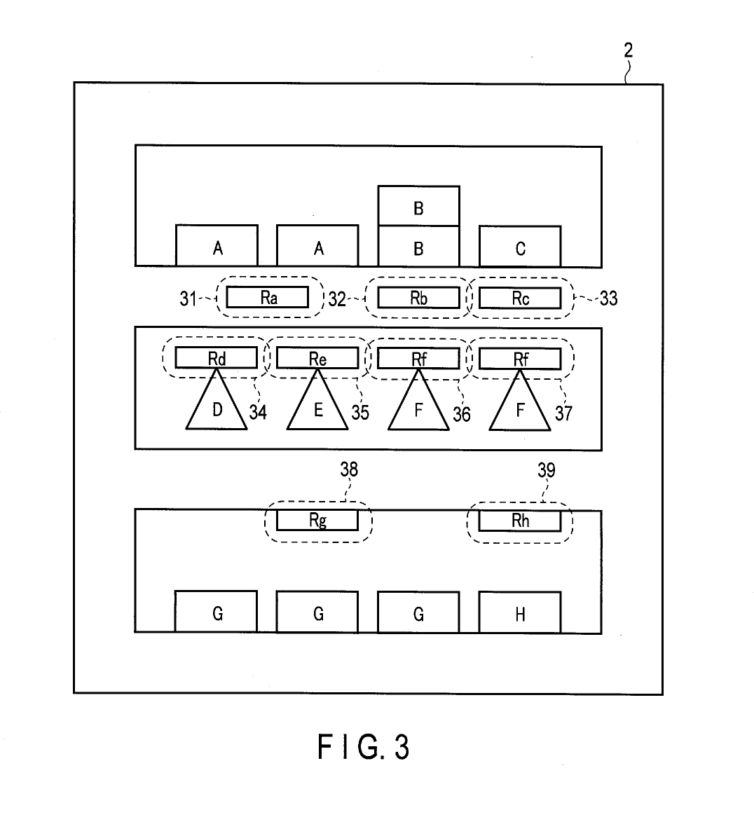

FIG. 3 is a view illustrating an example of the arrangement of a plurality of kinds of products and a plurality of kinds of labels in the display rack 2.

It is now assumed that, in the arrangement example illustrated in FIG. 3, labels Ra to Rh are labels which correspond to products A to H and display information relating to the products A to H.

The arrangement example illustrated in FIG. 3 is an example in which the labels Ra to Rh corresponding to the products A to H are arranged according to the following rules 1 to 5.

Rule 1: As regards products that are directly placed on a shelf other than the lowermost shelf, a label is disposed under the products (on a lower side frame).

Rule 2: As regards products that are stacked on a shelf other than the lowermost shelf, one label is disposed under the lowermost product (on a lower side frame).

Rule 3: As regards products that are hung, a label is disposed on the upper side of products of each row. (Alternatively, as regards products on a shelf of hung products (middle shelf in the example of FIG. 3), a label is disposed immediately above the products.)

Rule 4: As regards products that are directly placed on the lowermost shelf, a label is disposed on the upper side of the products (a label is hung from an upper side frame).

Rule 5: As regards the same kind of products, excluding hung products, which are arranged in a plurality of rows, one label is disposed with reference to the center position of the plural rows.

In the arrangement example illustrated in FIG. 3, the products A are arranged in two rows on the uppermost shelf (a shelf other than the lowermost shelf). Accordingly, the label Ra corresponding to the products A is disposed in an area 31 by applying rule 1 and rule 5. In addition, the products B are stacked on the uppermost shelf (a shelf other than the lowermost shelf). Accordingly, the label Rb corresponding to the products B is disposed in an area 32 by applying rule 1 and rule 2. The products C are disposed in one row on the uppermost shelf (a shelf other than the lowermost shelf). Accordingly, the label Rc corresponding to the products C is disposed in an area 33 by applying rule 1.

The products D are products that are hung (products disposed on a middle shelf that is a shelf of hung products). Accordingly, the label Rd corresponding to the products D is disposed in an area 34 by applying rule 3. The products E are products that are hung (products disposed on the shelf (middle) that is the shelf of hung products). Accordingly, the label Re corresponding to the products E is disposed in an area 35 by applying rule 3. The products F are products that are hung (products disposed on the shelf (middle) that is the shelf of hung products). Accordingly, the labels Rf corresponding to the products F are disposed in areas 36 and 37 corresponding to the respective rows of products F by applying rule 3.

In addition, the products G are arranged in three rows on the lowermost shelf. Accordingly, the label Rg corresponding to the products G is disposed in an area 38 by applying rule 4 and rule 5. Besides, the products H are arranged in one row on the lowermost shelf. Accordingly, the label Rh corresponding to the products H is disposed in an area 39 by applying rule 4.

As described above, the arrangement rules stipulate the positional relationship between products and labels, which corresponds to the state of products or the state of the shelves of the rack. In addition, the arrangement rules may specify the positional relationship between products and labels in association with respective kinds of products. In the configuration example of FIG. 2, the arrangement rules are stored in the rule DB 23b of the storage 23 which the computer 11 of the article management apparatus 1 includes. The processor 21 of the article management apparatus 1 can specify, based on the arrangement rules of the rule DB 23b, the correct position of the label for the product that is specified from the photography image. Specifically, the article management apparatus 1 can determine whether the positional relation of the labels to the respective products existing in the photography image meets the arrangement rules of the rule DB 23b. In addition, by referring to the arrangement rules, the article management apparatus 1 can also specify the areas (detection area of labels) where labels should normally exist, from the positions of products in the photography image.

Next, an operation example of the article management apparatus 1 according to the first embodiment will be described.

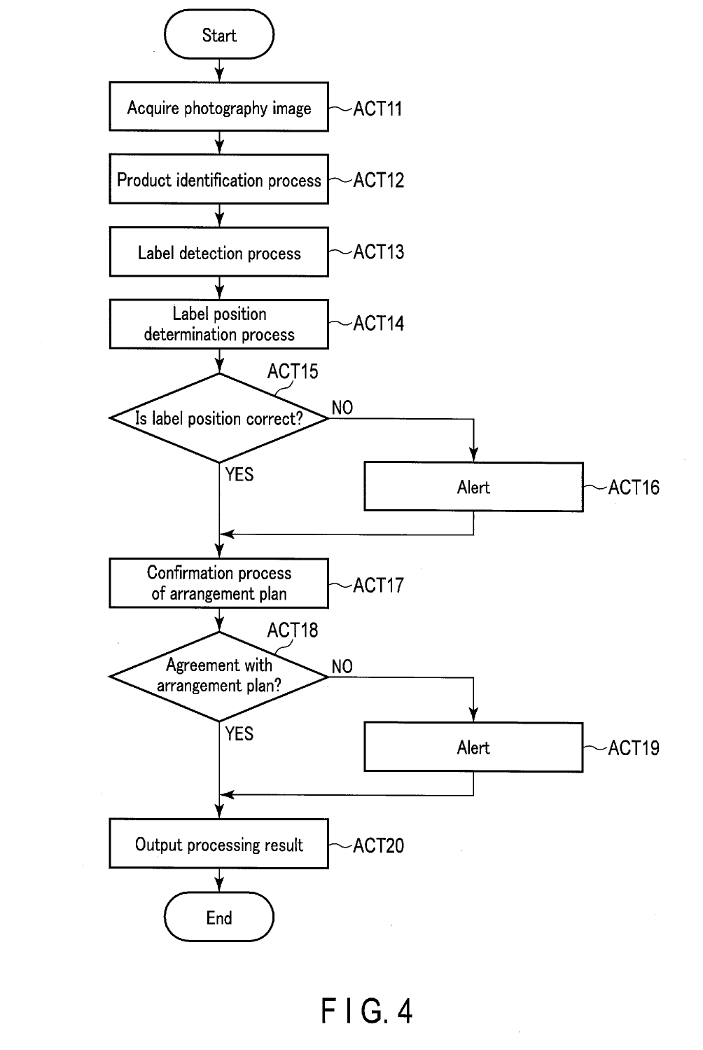

FIG. 4 is a flowchart for describing an operation example of the article management apparatus 1 of the first embodiment.

In the article management apparatus 1, the computer 11 executes a process of checking the positional relationship between products and labels, based on a photography image of a check range, which the camera 12 photographs. To start with, the processor 21 of the computer 11 sends an instruction for photographing a check range to the camera 12. The camera 12 photographs an image in accordance with the instruction from the processor 21. For example, the camera 12 photographs an image of the entirety of the display rack 2 that is the check range, while moving the photography range in accordance with the movement of the truck 13 or the like. In addition, the camera 12 may photograph such a plurality of photography images as to cover the entirety of the check change, while moving the photography range. The camera 12 delivers the captured photography image to the computer 11 via the camera I/F 24.

The processor 21 of the computer 11 acquires the photography image, which the camera 12 photographs, through the camera I/F 24 (ACT 11). For example, in the case of acquiring a plurality of photography images which were acquired while moving the photography area, the processor 21 generates an image (photography image of the check range) of the entirety of the display rack 2 that is the check range, from the plural acquired photography images.

Upon acquiring the photography image of the check range, the processor 21 executes a product identification process of identifying products in the photography image (ACT 12). In the product identification process, the processor 21 specifies the kind of product and the position of disposition of the product in the acquired photography image. For example, the processor 21 extracts a local characteristic amount of SIFT (Scale Invariant Feature Transform) or the like from the photography image, and specifies the product and the product position by matching the extracted local characteristic amount with SIFT information of the product identification information. In addition, the processor 21 may identify products by, for example, characteristic point matching, template matching, 3D matching, characteristic amount matching, character string matching, or numerical sequence matching. However, the product identification process is not limited to a specific method as described above.

After executing the product identification process on the photography image, the processor 21 executes a label detection process of detecting labels from the photography image (ACT 13). In the label detection process, the processor 21 specifies the positions of labels corresponding to various kinds of products in the photography image. The label detection process may be any process if the process can detect the positions of labels from the photography image. Incidentally, an operation example of the label detection process will be described later in detail.

Upon detecting the labels from the photography image, the processor 21 executes a label position determination process of determining whether the positional relationship between the positions of products and the positions of labels meets prescribed arrangement rules (ACT 14). The label position determination process is a process of determining whether the labels for the products, which were identified from the photography image, are disposed at correct positions according to the arrangement rules which are applied to these products. Incidentally, an operation example of the label position determination process will be described later in detail.

If the processor 21 determines, by the label position determination process, that the labels are not disposed at correct positions relative to the products (ACT 15, NO), the processor 21 outputs an alert notifying that the positions of labels are not correct (ACT 16). For example, as the alert, the processor 21 displays on the display 15 that the label position is not correct. The processor 21 may display a product (or the position of a product), the label for which is not at the correct position. In addition, the processor 21 may produce an alert sound by an alarm.

If the processor 21 determined that the labels for the respective products are at the correct positions (ACT 15, YES), or if the processor 21 output the alert, the processor 21 terminates the label position determination process. Upon terminating the label position determination process, the processor 21 determines whether the arrangement of respective products in the photography image agrees with the arrangement plan (ACT 17). Based on the arrangement plan stored in the storage area 23c, the processor 21 determines whether the arrangement of the products detected from the photography image agrees with the arrangement plan. In addition, based on the arrangement plan stored in the storage area (arrangement plan DB) 23c, the processor 21 may also determine whether the positions of the labels detected from the photography image agree with the arrangement plan.

If the processor 21 determines that the arrangement of products in the photography image fails to agree with the arrangement plan (ACT 18, NO), the processor 21 outputs an alert notifying that the arrangement of products fails to agree with the arrangement plan (ACT 19). For example, as the alert, the processor 21 displays on the display 15 that the arrangement of products or labels fails to agree with the arrangement plan. In addition, the processor 21 may display information indicating a product or a label, which fails to agree with the product arrangement plan. Besides, the processor 21 may produce an alert sound by an alarm.

In the meantime, when a check of arrangement positions of products based on the arrangement plan is not executed, the process of ACT 17 to ACT 19 may be omitted. In addition, the process of ACT 17 to ACT 19 may be executed in accordance with the operator's instruction.

If the above process is completed, the processor 21 outputs a processing result (ACT 20). For example, the processor 21 displays on the display 15 a processing result including a result of the label position determination process and a check result of the arrangement positions of products based on the arrangement plan. Besides, the processor 21 may transmit the above processing result to a communicable external apparatus.

Next, an operation example of the label detection process by the article management apparatus 1 will be described.

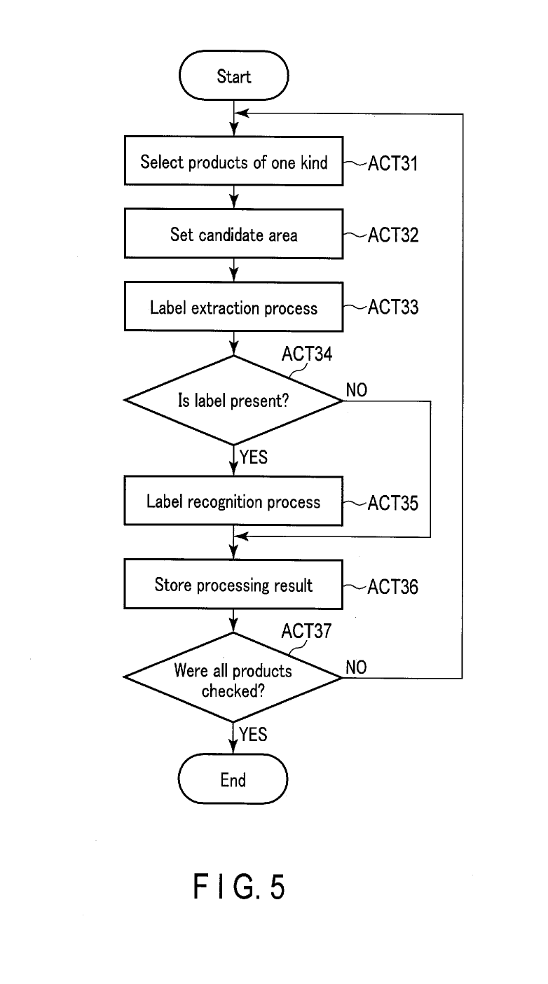

FIG. 5 is a flowchart for describing an operation example of the label detection process in the article management apparatus 1 according to the first embodiment.

The label detection process is executed, for example, as the process of the above-described ACT 13. It should suffice if the label detection process is a process of detecting the positions of labels from the photography image, and various processing methods are applicable. Here, a description is given of a process example in which the processor 21 detects labels for the respective kinds of products specified from the photography image.

After executing the product identification process on the photography image, the processor 21 selects products that are label detection targets, from the products specified in the photography image (ACT 31). Here, since the operation is assumed in which labels are arranged in association with the respective kinds of products, it is assumed that products of one kind are selected. If the products of one kind are selected, the processor 21 sets a detection area of a label in the photography image, with reference to the position of specified products (ACT 32). For example, the processor 21 may set, as the detection area of the label, an area of a predetermined range having a base point at the position of target products (for example, a lower side or upper side area of products).

In addition, the processor 21 may set the detection area of the label by referring to the arrangement rule that is applied to the target products. In the case of setting the detection area of the label by referring to the arrangement rule, the processor 21 acquires from the rule DB 23b the arrangement rule that is applied to the products. Upon acquiring the arrangement rule that is applied to the products, the processer 21 estimates an area where the label is to be normally disposed, based on the position of the products in the photography image and the acquired arrangement rule. The processor 21 sets, as the detection area of the label, the area including the area where the label is to be normally disposed, which was estimated based on the arrangement rule.

Upon setting the label detection area, the processor 21 executes a label extraction process of extracting (detecting) a label in the label detection area which was set in the photography image (ACT 33). The method of the label extraction process is not limited to a specific method. For example, the processor 21 may execute the label extraction process by using information (label identification information) for specifying respective kinds of labels. In this case, the label identification information is information of image samples for various kinds of labels, or a local characteristic amount such as SIFT or HOG (Histogram of Oriented Gradients). This label identification information may be stored in the storage 23.

If the processor 21 extracted the label from the label detection area by the label extraction process (ACT 34, YES), the processor 21 executes a label recognition process of recognizing the content of the extracted label (ACT 35). The label recognition process may be any process if the process can recognize the information that can identify the product to which the content of the detected label (the information that the label displays) corresponds. For example, the processor 21 recognizes the content of the label by recognizing by OCR a character string which the label displays. Alternatively, the processor 21 may recognize the content of the label by decoding a bar code which the label displays. Alternatively, the processor 21 may be connected to an RFID reader which reads information from an RFID that is embedded in the label, and may recognize the content of the label from the information that the RFID reader reads. Incidentally, in the case of an operation mode which does not check the content of the label (for example, in the case of an operation mode which checks only the position of the label), the process of ACT 35 may be omitted.

If the processor 21 successfully obtained the result of the recognition process on the detected label or if the processor 21 failed to detect the label (ACT 34, NO), the processor 21 stores the processing result in the storage 23 or memory 22 (ACT 36). This processing result is a result of the label detection process corresponding to the products selected in ACT 31. This processing result includes information indicating the position of the label detected (extracted) from the photography image, and information indicating the recognition process result on the detected label.

Upon storing the processing result corresponding to the selected products, the processor 21 determines whether the detection of labels was completed for all kinds of products specified from the photography image (ACT 37). If the processor determined that the detection of labels is not completed for all kinds of products (ACT 37, NO), the processor 21 returns to ACT 31, and executes the label detection process for the next products. On the other hand, if the processor determined that the detection of labels was completed for all kinds of products (ACT 37, YES), the processor 21 finishes the label detection process on the photography image.

By the above process, the processor 21 of the computer 11 stores in the storage 23 the processing result of the label detection process corresponding to all kinds of products specified from the photography image.

Next, an operation example of the label position determination process by the article management apparatus 1 will be described.

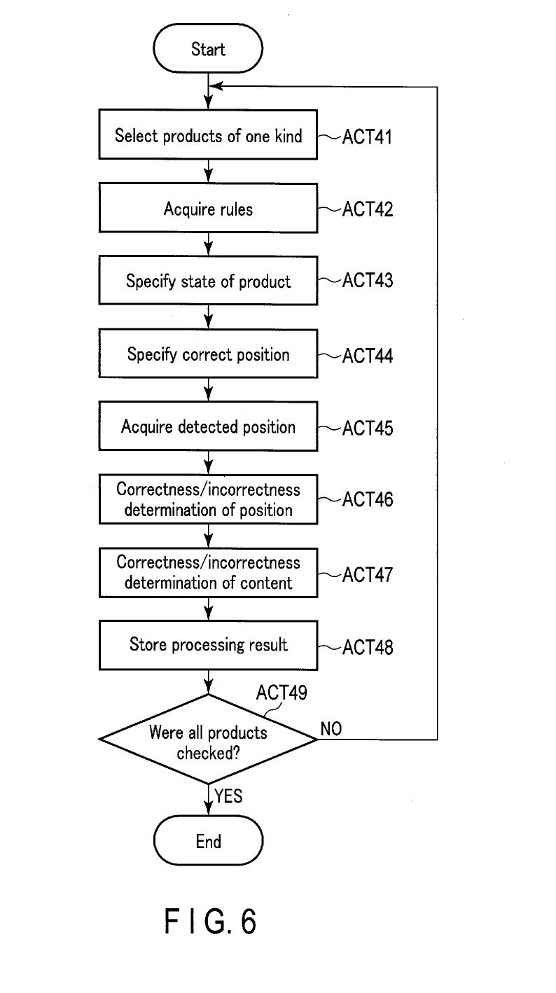

FIG. 6 is a flowchart for describing an operation example of the label position determination process by the article management apparatus 1 of the first embodiment.

The label position determination process is executed, for example, as the process of the above-described ACT 14. It should suffice if the label position determination process is a process of determining whether the labels corresponding to the products, which were specified from the photography image, are located at the correct position relative to the products, and various processing methods are applicable. Here, a description is given of a process example in which the processor 21 determines whether the position of the label corresponding to each kind of products specified from the photography image is the correct position according to the arrangement rule.

To start with, the processor 21 selects products of one kind, from the products specified from the photography image (ACT 41). Upon selecting the products, the processor 21 acquires from the rule DB 23b the arrangement rule which is applied to the selected products (ACT 42). Upon acquiring the arrangement rule, the processor 21 specifies the state of the selected products in the photography image (ACT 43). Here, the processor 21 specifies the state of products for applying the arrangement rule. For example, when the arrangement rules illustrated in FIG. 3 are applied, the processor 21 specifies, as the state of products, the shelf on which the products are disposed, the manner of placement of products (hanging, or direct placement), disposition in one row or plural rows, and disposition in stacking or non-stacking.

Upon specifying the state of products, the processor 21 specifies the correct label position corresponding to the state of products according to the arrangement rule (ACT 44). For example, according to the arrangement rules illustrated in FIG. 3, the processor 21 specifies the area 31 as the correct label position as regards the products A.

Upon specifying the correct label position according to the arrangement rule, the processor 21 acquires the position of the detected label from the photography image (ACT 45). For example, the processor 21 reads from the storage 3 (or memory 22) the information indicating the position of the label corresponding to the products detected from the photography image by the above-described label detection process. In addition, the processor 21 may execute, in ACT 45, the process of above-described ACT 32 to ACT 36 as the label detection process corresponding to the products.

Upon acquiring the position of the label detected from the photography image, the processor 21 executes correctness/incorrectness determination of position as to whether the position of the detected label is the correct label position relative to the products (ACT 46). Here, the processor 21 determines the correctness/incorrectness of position, by determining whether the position of the label detected from the photography image agrees with the correct position of the label specified according to the rules. In addition, the processor 21 may determine the correctness/incorrectness of position, by determining whether the position of the detected label exists in an allowable range which is set based on the specified correct label position.

Besides, the processor 21 may rectify the correct label position specified according to the rules, which is the target of comparison with the detected label position. For example, the processor 21 may detect the frame of the display rack 2 from the photography image, and may rectify the correct label position specified according to the rules, in accordance with the position of the frame. In the actual mode of operational use, in many cases, the label is attached to the frame of the display rack 2. Thus, by rectifying the correct label position in accordance with the frame, the position determination corresponding to the actual state of the display rack 2 becomes possible.

Additionally, the processor 21 may rectify the correct label position specified according to the rules, in accordance with the state of the photography image. For example, the processor 21 may determine the direction of photographing or the distance of photographing from the photography image, and may rectify the correct label position specified according to the rules, in accordance with the determined direction of photographing or distance of photographing.

Upon determining the correctness/incorrectness of the position of the label detected from the photography image, the processor 21 further executes correctness/incorrectness determination of content as to whether the content of the detected label is correct or not (ACT 47). The processor 21 determines the correctness/incorrectness of content, by determining whether the content of the label detected from the photography image matches with the information of the selected products. For example, the processor 21 determines the correctness/incorrectness of content, by determining whether the result of the label recognition process in the above-described label detection process matches with the information of the products. Specifically, by the correctness/incorrectness determination of content, the processor 21 confirms whether the label existing at the position corresponding to the products specified from the photography image displays the information corresponding to the products.

If the correctness/incorrectness determination of the position of the label relative to the products and the correctness/incorrectness determination of the content of the label are finished, the processor 21 stores the information indicative of the processing results in the storage 23 or memory 22 (ACT 48). The processing results include the result of correctness/incorrectness determination of position and the result of correctness/incorrectness determination of content, as the results of the label position determination process on the selected products.

Upon storing the results of the label position determination process on the selected products, the processor 21 determines whether the label position determination process on all products specified from the photography image was completed or not (ACT 49). If the processor 21 determined that the label position determination process on all products is not completed (ACT 49, NO), the processor 21 returns to ACT 41, and executes the label position determination process on the next products. In addition, if the processor 21 determined that the label position determination process on all products was completed (ACT 49, YES), the processor 21 terminates the label position determination process on the photography image.

As described above, the article management apparatus according to the first embodiment acquires a photography image captured by photographing the check range including the arrangement area where the products and labels are arranged. The article management apparatus specifies the kinds and positions of products from the acquired photography image. The article management apparatus specifies the positions of the labels corresponding to the products specified in the acquired photography image. The article management apparatus determines whether the products and labels specified from the photography image are in the positional relationship according to the arrangement rules.

According to this first embodiment, by photographing the display rack in which the products and labels are arranged, the article management apparatus can confirm whether the products and labels arranged in the display rack are in the correct positional relationship. In addition, the article management apparatus determines, according to the arrangement rules, the correctness/incorrectness of the positional relationship between the products and labels specified from the photography image. Thus, according to the first embodiment, whether the products and labels are arranged in the correct positional relationship can be confirmed even without information such as a product arrangement plan view.

Additionally, when the article management apparatus determined that the positional relationship between products and labels is not correct, the article management apparatus outputs an alert indicating that there is a problem with the position of the label, or an alert indicating a location where there is a problem with the arrangement position. According to this article management apparatus, the article management apparatus can clearly notify that the positional relationship between products and labels has a problem, or can clearly indicate a location where the positional relationship between products and labels has a problem.

Additionally, the article management apparatus may recognize the information which the labels indicate, and may confirm whether the specified products match with the labels corresponding to these products. This article management apparatus can confirm that the labels displaying the information of products are correctly arranged relative to the products, even without a product arrangement plan view.

Additionally, the article management apparatus refers to the arrangement rules corresponding to the state of products, and determines the correctness/incorrectness of the positions of the products and labels, based on the state of products specified from the photography image. Thereby, the article management apparatus can exactly determine the position of the label corresponding to the state of products. For example, the above-described article management apparatus determines the manner of disposition of products (e.g. hanging, or direct placement) as the state of specified products, and determines the position of the label in accordance with the manner of disposition of products. Thereby, the article management apparatus can exactly determine the position of label corresponding to the manner of disposition of products.

Additionally, the article management apparatus may set arrangement rules for the shelves of the rack where the specified products are arranged. For example, such arrangement rules may be set that, as regards the products on the lowermost shelf, the label is disposed on the upper side of the products, and that, as regards the products which are hung in the middle shelf, the label is disposed on the upper side of the hung products. Thereby, the article management apparatus can exactly determine the position of the label corresponding to the shelf of the rack.

Additionally, the article management apparatus may specify a label detection area based on the arrangement rules, from the position of products specified from the photography image, and may execute label detection with respect to only the label detection area. Thereby, the article management apparatus can realize enhancement in label detection precision or label detection speed based on the position of products in the photography image. Besides, in the label detection process, the article management apparatus may detect the frame of the rack from the photography image, and may restrict the label detection area based on the position of the frame. For example, the article management apparatus restricts the label detection area within the frame area as regards the label that is disposed on the frame, and restricts the label detection area to the lower side of the frame as regards the label that is hung from the frame. Thereby, the article management apparatus can enhance the precision in specifying the label detection area according to the arrangement rules.

Additionally, the article management apparatus may check the positional relationship between products and labels, and may confirm the position of products and/or the position of labels in the display rack, based on a product arrangement plan view. Thereby, the article management apparatus can confirm not only the positional relationship between individual products and labels, but can also confirm whether the positions of products and/or positions of labels in the entire rack are as planned or not.

### Second Embodiment

Next, a second embodiment will be described.

An article management apparatus 1′ according to the second embodiment determines whether the number of labels, which is estimated in association with all products specified from a photography image, matches with the number of labels, which is actually detected from the photography image. The article management apparatus 1′ according to the second embodiment can be realized by the same hardware configuration as the article management apparatus 1 according to the first embodiment, which was described with reference to FIG. 1 and FIG. 2. Thus, a detailed description of the hardware configuration in the article management apparatus 1′ according to the second embodiment is omitted here.

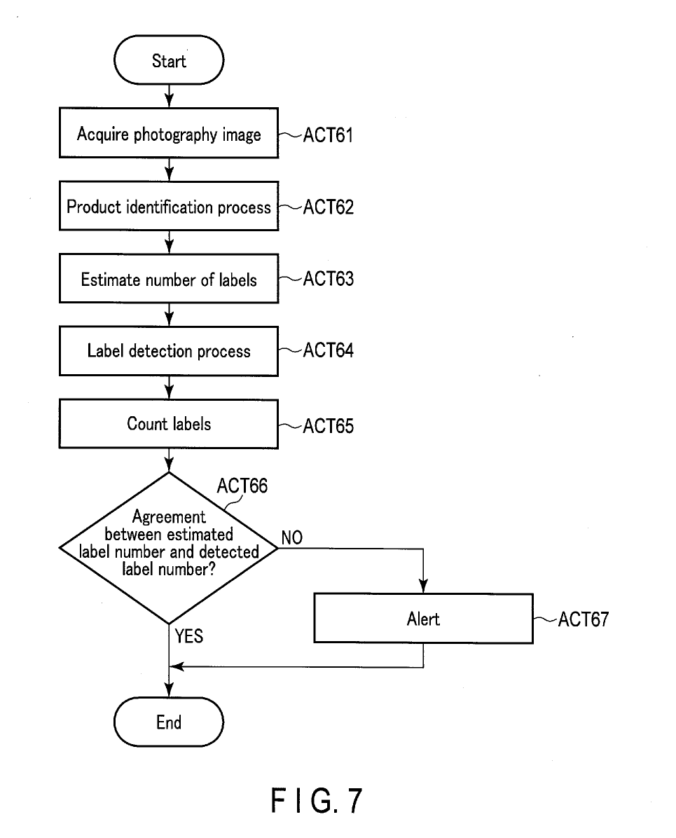

FIG. 7 is a flowchart for describing an operation example of the article management apparatus 1′ of the second embodiment.

In the article management apparatus 1′ of the second embodiment, the computer 11 executes a process of checking the total number of labels in a photography image which the camera 12 photographs. The processor 21 of the computer 11 instructs the camera 12 to photograph a check range, and acquires through the camera I/F 24 a photography image which the camera 12 photographs (ACT 61). Here, the processor 21 acquires the photography image of the entirety of the display rack 2 that is the check range. Upon acquiring the photography image of the check range, the processor 21 executes a product identification process of identifying the products in the photography image (ACT 62). In the product identification process, the processor 21 specifies the kinds and positions of all products existing in the acquired photography image. Incidentally, the process of ACT 61 and ACT 62 may be the same as the process of ACT 11 and ACT 12 described in the first embodiment.

Upon identifying all products existing in the photography image, the processor 21 acquires arrangement rules from the rule DB 23b. Based on the acquired arrangement rules, the processor 21 estimates labels which are to be disposed for the products existing in the photography image, and estimates the number of labels which are to be present in the photography image (ACT 63). If the products are exactly identified, the number of labels, which is estimated from the identified products, becomes a theoretical value of the number of labels which are to be present in the photography image (the number of labels which are to be disposed according to the arrangement rules). Here, the number of labels, which is estimated based on the products identified from the photography image and the arrangement rules, is referred to as “estimated label number”.

Upon specifying the estimated label number, the processor 21 executes a label detection process of detecting, from the photography image, all labels existing in the photography image (ACT 64). Here, it is assumed that the processor 21 sets, for example, the entirety of the photography image as a detection area, and detects all labels existing in the photography image.

Upon finishing the detection of labels in the entirety of the photography image, the processor 21 counts the total number of labels which were actually detected from the photography image (ACT 65). The total number of labels detected from the photography image is the number of labels which actually exist in the photography range of the photography image. Here, the total number of labels detected from the entirety of the photography image is referred to as “detected label number”.

Upon determining the detected label number, the processor 21 determines whether the number of labels estimated from the identified products (“estimated label number”) agrees with the detected label number (ACT 66).

If the estimated label number agrees with the detected label number (ACT 66, YES), the processor 21 determines that the number of labels matches with the products existing in the photography image. When the estimated label number agrees with the detected label number, the processor 21 displays on the display 15, as a processing result, that the number of labels in the photography image (photography range) is normal, and terminates the process. In addition, the processor 21 may display on the display 15 the number of labels estimated from the identified products and the number of actually detected labels.

On the other hand, if the estimated label number disagrees with the detected label number (ACT 66, NO), the processor 21 determines that the number of labels does not match with the products existing in the photography image. When the estimated label number disagrees with the detected label number, the processor 21 outputs an alert indicating that the number of labels for the products is mismatching (ACT 67). For example, the processor 21 displays on the display 15, as the alert, that the number of labels for the products is mismatching. In addition, the processor 21 may display the number of labels estimated from the identified products and the number of actually detected labels. Besides, the processor 21 may produce an alarm.

As described above, the article management apparatus according to the second embodiment identifies all products in the photography image, and estimates the number of labels corresponding to all identified products, based on the arrangement rules. The article management apparatus detects all labels in the photography image, and counts the number of labels detected from the photography image. If the estimated label number disagrees with the detected label number, the article management apparatus generates an alert. According to this article management apparatus, the user can confirm whether the number of labels in the photography image is correct or not.

### Third Embodiment

Next, a third embodiment will be described.

An article management apparatus 1″ according to the third embodiment executes, with respect to a photography image, correctness/incorrectness determination of the positional relationship between products and labels, and determination of matching between the estimated label number and the detected label number. The article management apparatus 1″ according to the third embodiment can be realized by the same hardware configuration as the article management apparatus 1 according to the first embodiment, which was described with reference to FIG. 1 and FIG. 2. Thus, a detailed description of the hardware configuration in the article management apparatus 1″ according to the third embodiment is omitted here.

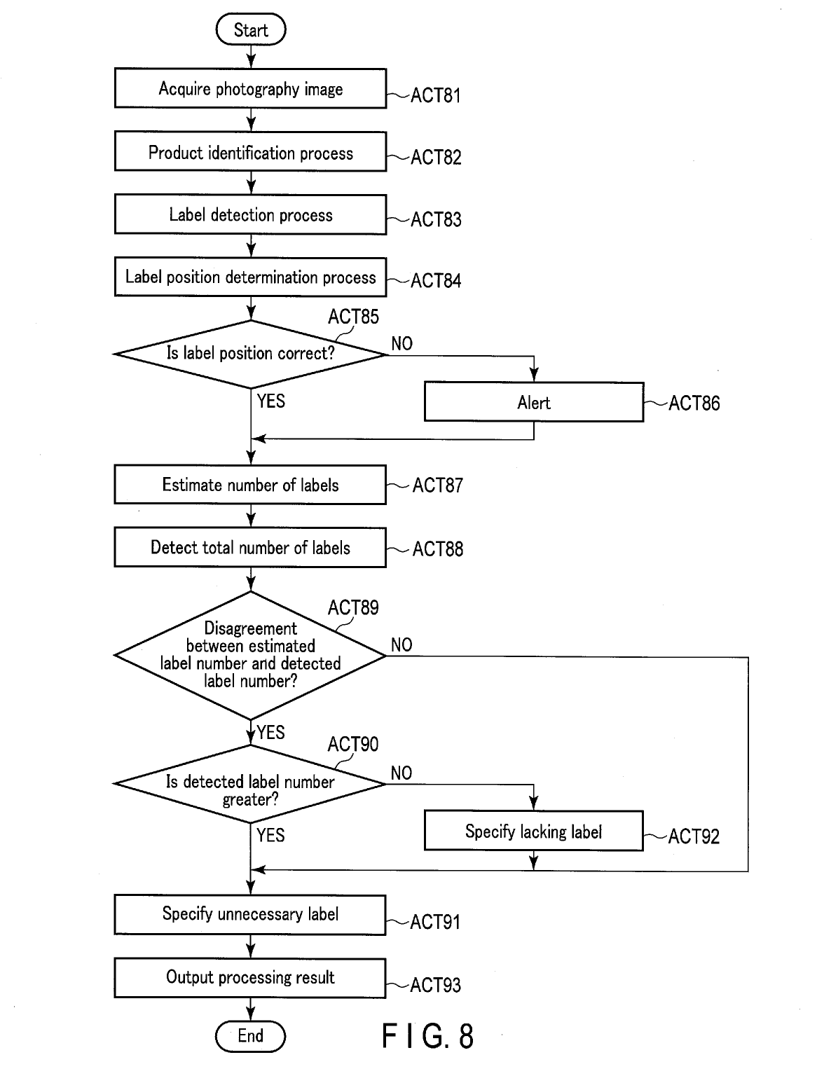

FIG. 8 is a flowchart for describing an operation example of the article management apparatus 1″ of the third embodiment.

The computer 11 of the article management apparatus 1″ of the third embodiment checks the positional relationship between products and labels and checks the number of labels, based on a photography image of the camera 12. The processor 21 of the computer 11 instructs the camera 12 to photograph a check range, and acquires through the camera I/F 24 a photography image which the camera 12 photographs (ACT 81). Here, the processor 21 acquires the photography image of the entirety of the rack that is the check range. Upon acquiring the photography image of the check range, the processor 21 executes a product identification process of identifying the products in the photography image (ACT 82). In the product identification process, the processor 21 specifies the kinds and positions of all products existing in the acquired photography image. Incidentally, the process of ACT 81 and ACT 82 may be the same as the process of ACT 11 and ACT 12 described in the first embodiment.

Upon identifying all products existing in the photography image, the processor 21 executes a label detection process of detecting labels from the photography image (ACT 83). The label detection process of ACT 83 is a process of detecting labels corresponding to the products from the photography image. For example, the label detection process of ACT 83 can be realized by the label detection process (ACT 13, ACT 31-37) described in the first embodiment.

Upon detecting the labels corresponding to the products from the photography image, the processor 21 executes a label position determination process of determining whether the positional relationship between the products and labels meets arrangement rules (ACT 84). The label position determination process of ACT 84 is a process of determining whether the labels are at the correct positions relative to the products which were identified from the photography image. For example, the label position determination process of ACT 84 can be realized by the label position determination process (ACT 14, ACT 41-49) described in the first embodiment.

If the processor 21 determined, by the label position determination process, that the labels are not disposed at correct positions (ACT 85, NO), the processor 21 outputs an alert notifying that there is a problem with the positions of labels (ACT 86). For example, the processor 21 displays, as the alert, which products are associated with the label that is not at the correct position. If the processor 21 determined that the labels are at correct corrections by the label position determination process (ACT 85, YES), or if the processor 21 output the alert, the processor 21 finishes the check of the positional relationship between the products and labels.

Upon finishing the check of the positional relationship between the products and labels, the processor 21 further checks the number of labels (ACT 87-91).

In checking the number of labels, the processor 21 first acquires the arrangement rules from the rule DB 23b. Based on the acquired arrangement rules, the processor 21 estimates labels which are to be disposed for the products existing in the photography image, and estimates the number of labels which are to be present in the photography image (ACT 87). The process of ACT 87 can be realized by the process of ACT 63 described in the second embodiment. In addition, as described in the second embodiment, the number of labels (“estimated label number”), which is estimated from the identified products, becomes a theoretical value of the number of labels which are to be present in the photography image.

Upon specifying the estimated label number, the processor 21 detects the total number of labels existing in the photography image (ACT 88). For example, the processor 21 counts the total number of labels (“detected label number”) existing in the entirety of the photography image, by the same process as described in ACT 64 and ACT 65 in the second embodiment.

Upon determining the detected label number, the processor 21 determines whether the estimated label number and the detected label number disagree or not (ACT 89).

If the estimated label number and the detected label number agree (ACT 89, NO), the processor 21 determines that the number of labels for the products existing in the photography image is matching. Here, if the processor 21 determined in ACT 85 that the labels are at correct positions relative to the products, the processor 21 can determine that there is no excess label, and all labels are at correct positions. In this case, the processor 21 displays on the display 15, as a processing result, that all labels in the photography image (photography range) are correctly disposed (ACT 93), and terminates the process. In addition, the processor 21 may display on the display 15 such information as the number of labels estimated from the identified products, and the number of actually detected labels.

In the meantime, if the processor 21 determines in ACT 85 that the labels are not at correct positions and determines that the estimated label number and the detected label number agree, the processor 21 can determine that there is no excess label, although there is a label that is not disposed at the correct position. In this case, the processor 21 may display on the display 15, as a processing result, that the number of labels is correct, as well as outputting the alert in the above-described ACT 86.

In addition, if the estimated label number and the detected level number disagree (ACT 89, YES), the processor 21 determines whether the number of labels in the photography image is excessive or deficient.

If the detected level number is less than the estimated label number (ACT 90, NO), the processor 21 determines that necessary labels are not disposed (there is a lacking label). If the processor 21 determines that there is a lacking label, the processor 21 specifies the lacking label (or products for which the label is not correctly disposed) (ACT 92). However, in the case of specifying the absence of a label corresponding to products by the label position determination process, the process of ACT 92 may be omitted. In this case, the processor 21 displays on the display 15, as a processing result, that there is a lacking label, as well as information indicative of products for which the label is not disposed (ACT 93), and terminates the process.

If the detected label number is greater than the estimated label number (ACT 90, YES), the processor 21 determines that there is an unnecessary label. If the processor 21 determines that there is an unnecessary label, the processor 21 specifies an unnecessary label existing in the photography image (ACT 92). For example, the processor 21 specifies, as the unnecessary label, a label which does not correspond to the products identified from the photography image, among the labels detected from the entirety of the photography image. In addition, the processor 21 may specify an unnecessary label existing in the photography image, for example, by using the result of the label position determination process of ACT 84. For example, if the processor 21 excludes the labels, which were determined to be at correct positions by the label position determination process, from a plurality of labels detected from the entirety of the photography image, the processor 21 can detect the position of the unnecessary label.

In this case, the processor 21 displays on the display 15, as a processing result, that there is an unnecessary label (ACT 93), and terminates the process. Besides, when the position of the unnecessary label was successfully detected, the processor 21 may display the position of the unnecessary label on the display 15.

By the above process, the processor 21 displays on the display 15, as the processing result, the information indicating the result of the label position determination process and the check result of the number of labels (e.g. an identification result of an unnecessary label or a lacking label). Moreover, the processor 21 may output information indicative of the processing result to an external apparatus.

In the meantime, in the process illustrated in FIG. 8, the check of the number of labels in ACT 87 to ACT 92 may be executed prior to the label position determination process (ACT 84). Besides, the arrangement check of products and/or labels based on the product arrangement plan, which was described in the first embodiment, may be executed along with the process illustrated in FIG. 8.

As described above, the article management apparatus according to the third embodiment checks the correctness/incorrectness of the positions of labels for products and checks the number of labels in the photography image. Thereby, according to the third embodiment, whether the labels are disposed at correct positions relative to the respective products can be checked, and an unnecessary label can be detected by checking the number of labels.

Incidentally, the third embodiment explains an example in which the first embodiment and second embodiment are implemented in combination. Specifically, the check of the positions of labels relative to the products can be realized by the process described in the first embodiment, and the check of the number of labels can be realized by the process described in the second embodiment. As a modification of the third embodiment, the check of the positions of labels relative to the products, which was described in the first embodiment, may be executed after the check of the number of labels, which was described in the second embodiment.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An article management apparatus comprising:
an interface configured to acquire a image captured by photographing a check range including an area where an article and a label are arranged; and
a processor configured to specify a kind and a position of the article existing in the image,
to specify a position of the label existing in the image, and
to determine whether the position of the label specified from the image is a correct position according to an arrangement rule, relative to the position of the article specified from the image.

2. The article management apparatus of claim 1, wherein the area where the article and the label are arranged is a rack in which the article and the label are arranged, and
the arrangement rule includes a rule stipulating a positional relationship between the article and the label in accordance with a state of the article in the rack.

3. The article management apparatus of claim 2, wherein the arrangement rule includes a rule stipulating the position of the label in association with each of types of articles, and
the processor is configured to determine whether the position of the label is the correct position, based on the rule corresponding to the type of the article specified from the image.

4. The article management apparatus of claim 3, wherein the processor is configured to specify information which the label determined to be at the correct position relative to the article specified from the image indicates, and to determine whether the information that the label indicates is indicative of article information of the article.

5. The article management apparatus of claim 1, wherein the processor is configured to specify a label detection area for detecting the label corresponding to the article specified from the image, based on the arrangement rule, and to detect the label from the label detection area.

6. The article management apparatus of claim 5, wherein the image is an image including as a photography area a rack in which the article and the label are arranged, and
the processor is configured to detect a frame which forms the rack in the image, and to rectify the label detection area in accordance with a position of the frame in the image.

7. The article management apparatus of claim 1, wherein the processor is further configured to determine, based on information indicating an arrangement plan for arranging various kinds of articles, whether the article specified from the image is disposed in accordance with the arrangement plan.

8. The article management apparatus of claim 1, wherein the processor is further configured to estimate, according to the arrangement rule, a number of labels corresponding to all articles specified in the image, and to determine whether the number of labels estimated according to the arrangement rule agrees with a total number of labels which exist in the image and are specified from the image.

9. An article management apparatus comprising:
an interface configured to acquire a image captured by photographing a check range including an area where an article and a label are arranged; and
a processor configured to specify kinds of all articles existing in the image,
to detecting a total number of all labels existing in the image, and
to estimate, according to an arrangement rule, a number of labels corresponding to all articles specified from the image, and to determine whether the number of labels, which was estimated according to the arrangement rule, agrees with the total number of labels detected from the image.

10. An article management method comprising:
acquiring a image captured by photographing a check range including an area where an article and a label are arranged;
specifying a kind and a position of the article existing in the image,
specifying a position of the label existing in the image, and
determining whether the position of the label specified from the image is a correct position according to an arrangement rule, relative to the position of the article specified from the image.
